(19) United States
(12) Patent Application Publication
(10) Pub. No.: US 2025/0294560 A1
(43) Pub. Date: Sep. 18, 2025

(54) APPARATUS AND METHOD FOR EFFICIENT UPLINK COMMUNICATIONS

(71) Applicant: Lenovo (Singapore) Pte Limited, Singapore (SG)

(72) Inventors: Joachim LÖHR, Wiesbaden (DE); Hossein BAGHERI, Urbana, IL (US); Vijay NANGIA, Woodridge, IL (US); Razvan-Andrei STOICA, Essen (DE)

(21) Appl. No.: 18/860,287

(22) PCT Filed: Apr. 24, 2023
(86) PCT No.: PCT/IB2023/054192

§ 371 Date: Oct. 25, 2024

Related U.S. Application Data
(60) Provisional application No. 63/335,156, filed on Apr. 26, 2022.

(51) Int. Cl. H04W 72/21; H04L 5/00; H04W 74/0816

(52) U.S. Cl. CPC H04W 72/21; H04L 5/0044; H04W 74/0816

(57) ABSTRACT

Various aspects of the present disclosure relate to a UE configured to determine that first data stored in the memory for an uplink transmission is not suitable for subsequent uplink scheduling based on a criterion, and trigger the transmission of a control message that indicates an amount of the first data that will not be provided in an uplink transmission.

### CROSS REFERENCE TO RELATED APPLICATIONS

This application claims priority to U.S. Provisional Patent Application No. 63/335,156, filed on Apr. 26, 2022, entitled APPARATUS AND METHOD FOR EFFICIENT UPLINK COMMUNICATIONS, which is hereby incorporated by reference in its entirety.

### TECHNICAL FIELD

The present disclosure relates to wireless communications, and more specifically to an apparatus and method for adapting uplink communications in a telecommunications system to improve the efficiency of uplink signaling.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

It is not always possible to transmit uplink signals within an allocated time budget. Some applications, such as applications related to mixed realities, do not use data from transmissions that exceed the packet delay budget (PDB), rendering such data redundant. Telecommunications systems would benefit from technology that minimizes redundant or unnecessary data transmissions.

### SUMMARY

The present disclosure relates to methods, apparatuses, and systems that support determining that data stored in a buffer for uplink communications is expected to be transmitted at a time that is too late for the data to be useful, and generating a control signal to inform the network of the changed status of the buffered data. By removing the late data from the buffer and not transmitting the late data, the UE may save power. The network may allocate resources that would otherwise be used to process the late data, thereby increasing network efficiency.

Some implementations of the method and apparatuses described herein may include an apparatus for wireless communication including a processor and a memory coupled with the processor, the processor configured to determine that first data stored in the memory for an uplink transmission is not suitable for subsequent uplink scheduling based on a criterion, and trigger the transmission of a control message that indicates an amount of the first data that will not be provided in an uplink transmission.

In some implementations of the method and apparatuses described herein, the first data is associated with at least one of a logical channel and a logical channel group.

In some implementations of the method and apparatuses described herein, the first data is stored in at least one of the packet data convergence protocol (PDCP) layer, the radio link control (RLC), and the medium access control (MAC) layer.

In some implementations of the method and apparatuses described herein, the criterion is based on at least one of a timer status and a packet loss threshold.

In some implementations of the method and apparatuses described herein, the timer is associated with a packet delay budget, and the criterion is expiration of the timer.

In some implementations of the method and apparatuses described herein, the threshold is associated with at least one of a packet loss rate or a percentage of lost packets, and the criterion is exceeding the threshold.

In some implementations of the method and apparatuses described herein, the control message is a MAC control element.

In some implementations of the method and apparatuses described herein, the MAC control element includes a buffer status report (BSR).

In some implementations of the method and apparatuses described herein, the control message is a scheduling request transmitted on the Physical uplink control channel (PUCCH).

In some implementations of the method and apparatuses described herein, the criterion is exceeding an application data budget for an application data unit.

Some implementations of the method and apparatuses described herein may include a method performed by user equipment in a telecommunications network including determining that first data stored in a memory of the user equipment for an uplink transmission is not suitable for subsequent uplink scheduling based on a criterion, generating a control message that indicates an amount of the first data that will not be provided in an uplink transmission, and transmitting the control message to a base station.

### BRIEF DESCRIPTION OF THE DRAWINGS

FIG. 1 illustrates an example of a wireless communications system that supports efficient uplink communications in accordance with aspects of the present disclosure.

FIG. 2 illustrates an example of a block diagram of a device that supports efficient uplink communications in accordance with aspects of the present disclosure.

FIGS. 3, 4, 5, 6, 7, 8 and 11 illustrate flowcharts of methods that support efficient uplink communications in accordance with aspects of the present disclosure.

FIG. 9 illustrates an example of an information element with a field for associated DRB identities.

FIG. 10 illustrates an example of a protocol stack with bearers of different priorities.

### DETAILED DESCRIPTION

In a wireless environment, it is not always possible to successfully complete uplink transmissions within a packet delay budget (PDB). Certain applications, including applications related to extended reality (XR) such as virtual reality and augmented reality, will discard late data, rendering late UE transmissions redundant.

XR applications may refer to real and virtual combined environments and human-machine interactions generated by computer technology and wearables. It includes representative forms such as augmented reality (AR), mixed reality (MR), virtual reality (VR) and the areas interpolated among them. The levels of virtuality range from partial sensory inputs to fully immersive VR. An aspect of XR is the extension of human experiences especially relating to the senses of existence (represented by VR) and the acquisition of cognition (represented by AR). XR is explained in more detail, for example, in 3GPP TR 26.928.

In cases when the decoding of a frame of an XR application is not possible anymore due to loss of a high percentage of packets of the frame or when the PDB of an application data unit (ADU) or frame or PDU set is exceeded, it is not beneficial to transmit the remaining data of the concerned ADU or frame since the application may not benefit from those transmissions. On the contrary, such late transmissions ultimately lead to increased UE power consumption and a waste of radio resources, leading to a negative impact on system capacity.

A service-oriented design considering XR traffic characteristics can provide more efficient XR service delivery. The XR traffic characteristics may include (a) variable packet arrival rate, such as packets coming at 30-120 frames/second with some jitter, (b) packets having variable and large packet size, (c) B-frames and P-frames being dependent on I-frames, and (d) the presence of multiple traffic or data flows such as pose and video scene in uplink. Efficient XR service delivery may be achieved by satisfying XR service requirements for a greater number of UEs, or in terms of UE power saving, for example.

The latency requirement of XR traffic on the radio access network (RAN) side, or air interface, is modelled as a packet delay budget (PDB). The PDB is a limited time budget for a packet to be transmitted over the air from a base station such as a next-generation NodeB (gNB) to a UE, or from a UE to a gNB. A delay budget can be also defined for an ADU, referred to as an ADU delay budget (ADB). An ADU may be the smallest unit of data that can be processed, e.g. processing for handling out of order traffic data, independently by an application. In the present disclosure, a protocol data unit (PDU) set may be used interchangeably with an ADU, so information and activity discussed with respect to an ADU applies to a PDU set and vice versa. A PDU set or ADU is comprised of one or more PDUs carrying the payload of one unit of information generated at the application level (e.g. frame(s) or video slice(s) etc. for XR Services).

For a given packet, the delay of the packet incurred in air interface is measured from the time that the packet arrives at the gNB to the time that it is successfully transferred to the UE. If the delay is larger than a given PDB for the packet, then the packet is said to violate PDB, otherwise the packet is said to be successfully delivered. The value of PDB may vary for different applications and traffic types, which can be 10-20 ms depending on the application (see TR 26.926).

According to R1-2112245, 5G arrival time of data bursts on the downlink can be quasi periodic i.e. periodic with jitter. Some of the factors leading to jitter in burst arrival include varying server render time, encoder time, RTP packetization time, link between server and 5G gateway etc. 3GPP agreed simulation assumptions for XR evaluation model DL traffic arrival jitter using truncated Gaussian distribution with mean: 0 ms, std. dev: 2 ms, range: [−4 ms, 4 ms] (baseline), [−5 ms, 5 ms] (optional).

Applications can have a certain delay requirement on an ADU, that may not be adequately translated into packet delay budget requirements. For example, if the ADU delay budget (ADB) is 10 ms, then a PDB can be set to 10 ms only if all packets of the ADU arrive at the 5G system at the same time. If the packets are spread out, then ADU delay budget may be measured either in terms of the arrival of the first packet of the ADU or the last packet of the ADU. In either case, a given ADB will result in different PDB requirements on different packets of the ADU. It is observed that specifying the ADB to the 5G system can be beneficial.

If one or both of a scheduler in a network entity, e.g. a gNB, and a UE is aware of delay budgets for a packet or ADU, the gNB can take this information into account in scheduling transmissions. For example, the gNB can prioritize transmissions close to their delay budget limit, and not schedule transmissions. The UE can also take advantage of such information to determine if an uplink transmission such as a Physical Uplink Control Channel (PUCCH) transmission in response to Physical Downlink Shared Channel (PDSCH), UL pose, or Physical Uplink Shared Channel (PUSCH) corresponding to a transmission that exceeds its delay budget can be dropped. In addition, the UE may not wait for re-transmission of a PDSCH and keep the erroneously received PDSCH in its buffer for soft combining with a re-transmission that never occurs. The UE may determine how much of its channel occupancy time can be shared with the gNB when using unlicensed spectrum.

The remaining delay budget for a downlink transmission can be indicated to the UE in downlink channel information (DCI), such as DCI for a packet for a video frame, slice or ADU, or via a medium access control-control element (MAC-CE) for a video frame, slice or ADU. The remaining budget for an uplink transmission can be indicated to the gNB via an uplink transmission such as uplink control information (UCI), a PUSCH transmission, etc. The present disclosure provides embodiments of an apparatus and system to indicate such remaining delay budget.

Embodiments of the present disclosure include a UE that is configured to transmit signals indicating that scheduled transmissions are useless. In addition, embodiments provide criteria for determining that data is late. The network may use this information to update the transmission schedule to replace the late data transmissions, and the UE may discard the useless data. For example, the UE may transmit a signal indicating that future planned uplink transmissions are late. In response, the network may allocate resources that otherwise would have been used by the late transmission.

In some embodiments of the present disclosure, a UE may consider the inter-dependency between different LCHs during uplink scheduling. The UE may suspend transmission of a specific LCH or bearer until a packet or ADU of another related bearer or LCH has been successfully transmitted.

Some embodiments relate to behavior on the transmitting and receiving sides when discarding “unnecessary” packets at the transmitter side, including control signaling to inform a receiver of discarded packets. Some embodiments consider a PDB during a logical channel prioritization (LCP) procedure.

The technology described by the present disclosure may improve the efficiency of a wireless system by eliminating useless uplink transmissions. Eliminating unnecessary transmissions can reduce system interference and release resources that can be allocated to useful transmissions. In addition, eliminating unnecessary transmissions can save power at the UE, thereby extending battery life.

Aspects of the present disclosure are described in the context of a wireless communications system. Aspects of the present disclosure are further illustrated and described with reference to device diagrams, flowcharts that relate to efficient uplink communications.

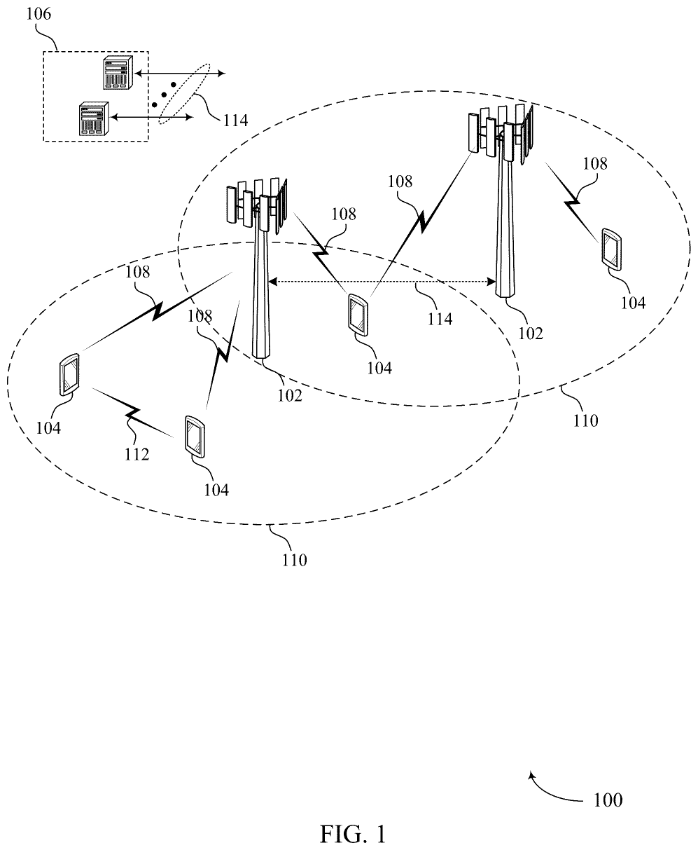

FIG. 1 illustrates an example of a wireless communications system 100 that supports efficient uplink communications in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a base transceiver station, an access point, a NodeB, an eNodeB (eNB), a next-generation NodeB (gNB), or other suitable terminology. A base station 102 and a UE 104 may communicate via a communication link 108, which may be a wireless or wired connection. For example, a base station 102 and a UE 104 may wireless communication over a Uu interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, N2, or another network interface). The base stations 102 may communication with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

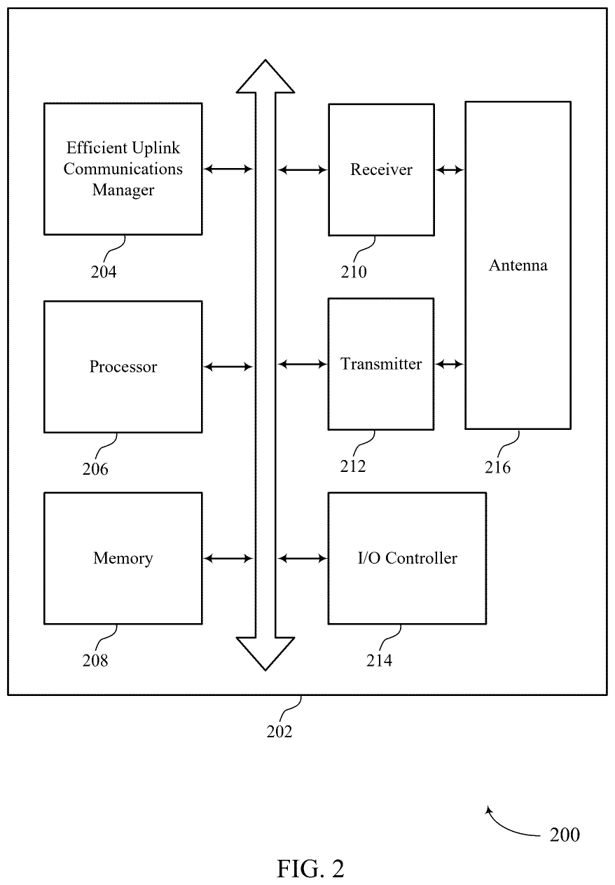

FIG. 2 illustrates an example of a block diagram 200 of a device 202 that supports efficient uplink communications in accordance with aspects of the present disclosure. The device 202 may be an example of a UE 104 as described herein. The device 202 may support wireless communication with one or more base stations 102, UEs 104, or any combination thereof. The device 202 may include components for bi-directional communications including components for transmitting and receiving communications, such as a communications manager 204, a processor 206, a memory 208, a receiver 210, transmitter 212, and an I/O controller 214. These components may be in electronic communication or otherwise coupled (e.g., operatively, communicatively, functionally, electronically, electrically) via one or more interfaces (e.g., buses).

The communications manager 204, the receiver 210, the transmitter 212, or various combinations thereof or various components thereof may be examples of means for performing various aspects of the present disclosure as described herein. For example, the communications manager 204, the receiver 210, the transmitter 212, or various combinations or components thereof may support a method for performing one or more of the functions described herein.

In some implementations, the communications manager 204, the receiver 210, the transmitter 212, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 206 and the memory 208 coupled with the processor 206 may be configured to perform one or more of the functions described herein (e.g., by executing, by the processor 206, instructions stored in the memory 208).

Additionally or alternatively, in some implementations, the communications manager 204, the receiver 210, the transmitter 212, or various combinations or components thereof may be implemented in code (e.g., as communications management software or firmware) executed by the processor 206. If implemented in code executed by the processor 206, the functions of the communications manager 204, the receiver 210, the transmitter 212, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 204 may be configured to perform various operations (e.g., receiving, monitoring, transmitting) using or otherwise in cooperation with the receiver 210, the transmitter 212, or both. For example, the communications manager 204 may receive information from the receiver 210, send information to the transmitter 212, or be integrated in combination with the receiver 210, the transmitter 212, or both to receive information, transmit information, or perform various other operations as described herein. Although the communications manager 204 is illustrated as a separate component, in some implementations, one or more functions described with reference to the communications manager 204 may be supported by or performed by the processor 206, the memory 208, or any combination thereof. For example, the memory 208 may store code, which may include instructions executable by the processor 206 to cause the device 202 to perform various aspects of the present disclosure as described herein, or the processor 206 and the memory 208 may be otherwise configured to perform or support such operations.

For example, the efficient uplink communications manager 204 may support wireless communication at a first device (e.g., the device 202) in accordance with examples as disclosed herein. The communications manager 204 may be configured as or otherwise support a memory coupled with the processor, the processor configured to determine that first data stored in the memory for an uplink transmission is not suitable for subsequent uplink scheduling based on a criterion, and trigger the transmission of a control message that indicates an amount of the first data that will not be provided in an uplink transmission.

The processor 206 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 206 may be configured to operate a memory array using a memory controller. In some other implementations, a memory controller may be integrated into the processor 206. The processor 206 may be configured to execute computer-readable instructions stored in a memory (e.g., the memory 208) to cause the device 202 to perform various functions of the present disclosure.

The memory 208 may include random access memory (RAM) and read-only memory (ROM). The memory 208 may store computer-readable, computer-executable code including instructions that, when executed by the processor 206 cause the device 202 to perform various functions described herein. The code may be stored in a non-transitory computer-readable medium such as system memory or another type of memory. In some implementations, the code may not be directly executable by the processor 206 but may cause a computer (e.g., when compiled and executed) to perform functions described herein. In some implementations, the memory 208 may include, among other things, a basic I/O system (BIOS) which may control basic hardware or software operation such as the interaction with peripheral components or devices.

The I/O controller 214 may manage input and output signals for the device 202. The I/O controller 214 may also manage peripherals not integrated into the device 202. In some implementations, the I/O controller 214 may represent a physical connection or port to an external peripheral. In some implementations, the I/O controller 214 may utilize an operating system such as iOS®, ANDROID®, MS-DOS®, MS-WINDOWS®, OS/2®, UNIX®, LINUX®, or another known operating system. In some implementations, the I/O controller 214 may be implemented as part of a processor, such as the processor 206. In some implementations, a user may interact with the device 202 via the I/O controller 214 or via hardware components controlled by the I/O controller 214.

In some implementations, the device 202 may include a single antenna 216. However, in some other implementations, the device 202 may have more than one antenna 216, which may be capable of concurrently transmitting or receiving multiple wireless transmissions. The receiver 210 and the transmitter 212 may communicate bi-directionally, via the one or more antennas 216, wired, or wireless links as described herein. For example, the receiver 210 and the transmitter 212 may represent a wireless transceiver and may communicate bi-directionally with another wireless transceiver. The transceiver may also include a modem to modulate the packets, to provide the modulated packets to one or more antennas 216 for transmission, and to demodulate packets received from the one or more antennas 216.

In embodiments of the present disclosure, a symbol, slot, subslot or time transmission interval (TTI) may be a time unit with a particular duration. For example, a symbol could be a fraction or percentage of an OFDM symbol length associated with a particular subcarrier spacing (SCS). An UL transmission, which may be an UL transmission burst, may be comprised of multiple transmissions of the same or different priority in case a priority potentially with gaps between the transmissions, where the gaps are short enough in duration to not necessitate performing a channel sensing or listen-before-talk (LBT) operation between the transmissions. In addition, the UE and the base station with which the UE is communicating may know which transport blocks (TBs) are associated with a packet and/or an application data unit (ADU), e.g., by a downlink control information (DCI) indication or a MAC control element (MAC-CE) indication.

In an embodiment, a UE provides an indication to the network that scheduling uplink resources for some logical channels (LCHs) and logical channel groups (LCGs) are no longer valid. Some applications, especially applications related to extended reality (XR), require data to be transmitted within a certain time period in order for the application to make use of that data. Such data may be referred to as late or invalid data. Late data is no longer useful to the application, and resources used to handle the late data are effectively wasted. Situations that lead to late data include high levels of packet loss, or when a packet data budget (PDB) is exceeded. Resources such as configured grant (CG) resources allocated to late data may be re-allocated by the network.

In an embodiment, a UE informs the network, for example by transmitting a signal to a gNB, that no further UL resources for UL transmissions of a specific LCH or LCG or set of LCHs or LCGs are necessary. Such new signaling may be beneficial for embodiments in which the decoding of a frame is not possible anymore due to a high percentage of packets of the frame being lost or when the PDB of an application data unit (ADU) or frame is exceeded. In those scenarios it is not useful to transmit the remaining data of the associated LCH, ADU or frame since the application may not benefit from those transmissions. On the contrary, such transmissions lead to unnecessarily increased UE power consumption and a waste of radio resources, which has a negative impact on the system capacity.

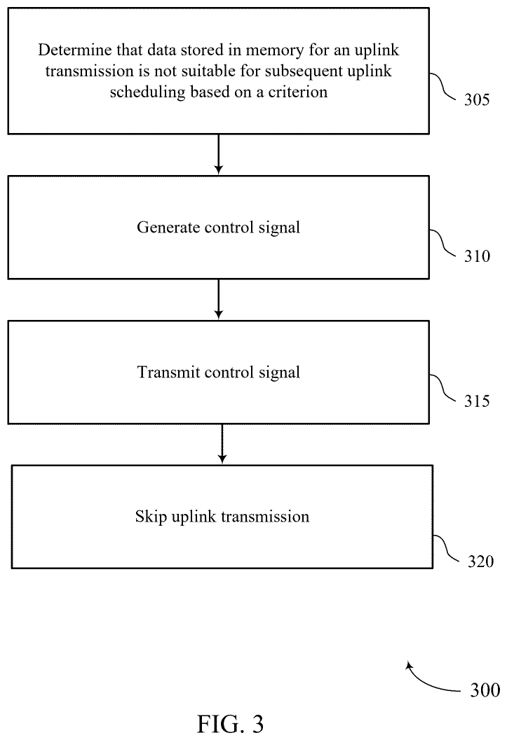

FIG. 3 illustrates a flowchart of a method 300 that supports efficient uplink communications in accordance with aspects of the present disclosure. The operations of the method 300 may be implemented by a device or its components as described herein. For example, the operations of the method 300 may be performed by a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware. Method 300 may only be performed for certain data, such as data that cannot be used by an application if it is late.

At 305, the method may include determining that first data stored in the memory for an uplink transmission is not suitable for subsequent uplink scheduling based on a criterion. The operations of 305 may be performed in accordance with examples as described herein. In some implementations, aspects of the operations of 305 may be performed by a device as described with reference to FIG. 1.

For example, a UE may determine that remaining packets of an ADU or frame which are still pending in the buffer for transmission are no longer useful by an application, and are therefore late or invalid data. In an embodiment, the UE performs this determination using lost packet information as a criterion. For example, the UE may compare a lost packet value, which may be a rate of lost packets or an amount of lost packets, to a threshold value. The amount of lost packets may be an amount of lost packets within a predetermined time. In particular, the amount of lost packets may be a percentage of packets that are lost within a time period. If the lost packet value exceeds the threshold value, then the UE may determine that data in the UE's buffer and associated with an ADU or frame is not suitable for subsequent uplink scheduling.

In another embodiment, the UE may compare an ADU or frame to a PDB. In particular, the UE may determine an amount of time under current transmission conditions for which it will take to transmit an ADU or frame, and compare that to a PDB. If the time to transmit the ADU or frame exceeds the PDB, then the UE determines that data in the ADU or frame is late data, and unsuitable for subsequent uplink scheduling. In an embodiment, the UE may distinguish data which is available for transmission, e.g. in a transmission buffer, between useful data which still can be transmitted within the associated PDB, and data which is unsuitable for subsequent uplink scheduling. In an embodiment, the UE may designate information in the buffer based on whether the data is expected to be transmitted within the PDB. Determining that data in the UE's buffer is late data may trigger the generation of a control signal.

At 310, the method may include generating a control signal. In an embodiment, the control signal indicates to a base station that a previously reported buffer status for a LCG is no longer valid. The operations of 310 may be performed in accordance with examples as described herein. In some implementations, aspects of the operations of 310 may be performed by a device as described with reference to FIG. 1. The control signal may indicate that data reported in a previous BSR continues to be valid, or is no longer valid, e.g. late data as determined at 305.

The control signal generated at 310 may include a new buffer status report (BSR). For example, the UE may generate a BSR that reports zero bytes for each LCH or LCG associated with the data that is not expected to be transmitted within a predetermined time at 305, e.g. late data. Accordingly, the control signal may indicate an amount of data from the UE's buffer that will not be provided in an uplink transmission.

In an embodiment, the control signal generated at 310 may be a BSR that only indicates timely or useful data. In such an embodiment, the BSR which only indicates useful or valid data may replace a previously reported BSR. The UE may discard the late data, and generate a new BSR at 310 using the timely or valid data remaining in the UE's buffer.

In an embodiment, the UE may generate a new scheduling request (SR) at 310. The new SR may inform the network that data in the UE's buffer is late as determined at 305. The SR may include an indication that informs the network that for the associated LCH (mapping between LCH and SR configuration), late data is pending in the buffer, and no further uplink resources are to be designated for the associated data. Accordingly, the new SR may be a negative SR that informs the network to not allocate uplink resources in a schedule.

In an embodiment, the control signal is a new PUCCH format that includes an indication with two bits that indicate three different states. The first state of the SR may indicate that a BSR has been triggered, e.g. for legacy usage. The second state may indicate that no valid or useful data is present in the UE buffer, and may be designated when late data is present in the UE's buffer. The third state may indicate no SR.

When the network receives a control signal indicating the second state, the network is informed that resources that were previously identified for an uplink transmission are no longer valid. The network may deactivate configured grant (CG) PUSCH resources allocated to the UE, and may re-allocate those resources to a different communication. The indication may be performed by multiplying SR data by an orthogonal sequence to provide the three states. After transmitting a control signal indicating the second state, the UE may not monitor the PDCCH for uplink DCI associated with the late data.

When the control signal is a BSR, the UE may generate a long BSR or a short BSR for a regular or periodic BSR. If more than one LCG is associated with valid and timely data for an uplink transmission, then the UE may generate and transmit a long BSR for all LCGs which have valid and timely data. Otherwise, the UE may generate and transmit a short BSR. In an embodiment, the UE generates and transmits a long BSR when a new BSR is triggered if at least one additional LCH or LCG has useful data, or if at least one additional LCH or LCG has late data which has not been reported to a base station in a previous BSR which has been explicitly or implicitly acknowledged by the base station.

In an embodiment, a UE may generate and transmit an ACK as HARQ feedback for a downlink transmission associated with an ADU or frame that includes late data as determined at 305. The ACK may be transmitted regardless of the outcome of decoding. In such an embodiment, the soft buffer may be flushed.

At 320, the method may include skipping an uplink transmission. The operations of 320 may be performed in accordance with examples as described herein. In some implementations, aspects of the operations of 320 may be performed by a device as described with reference to FIG. 1.

Skipping an uplink transmission at 320 may include skipping an UL DCI for late or unsuitable data as determined at 305. In an embodiment, the UE uses new criteria for skipping a transmission, which is the result of the determination at 305.

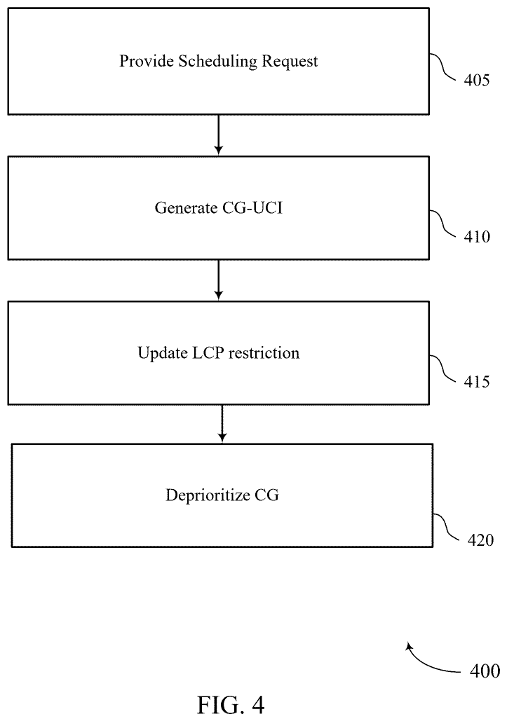

FIG. 4 illustrates a flowchart of a method 400 that supports processes associated with configured grants in accordance with aspects of the present disclosure. The operations of the method 400 may be implemented by a device or its components as described herein. For example, operations of the method 400 may be performed by a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

The UE with late data in its buffer and to which CG PUSCH resources have been allocated may indicate to the network that a CG PUSCH configuration or a group of CG configurations should be deactivated, and/or CG PUSCH resources of the CG configuration can be re-allocated, e.g. to other users, in method 400.

At 405, the method may include providing an SR. The operations of 405 may be performed in accordance with examples as described herein. In some implementations, aspects of the operations of 405 may be performed by a device as described with reference to FIG. 1.

If one or more CG configuration is activated for a UE, the UE may generate and transmit an SR associated with the CG configuration indicating that the one or more CG can be deactivated. When a CG configuration is activated, normal SR transmissions may be prohibited for the LCH mapped to the CG configuration, in which case a logicalChannelSR-Mask configuration can be used for the SR. When the CG configuration is deactivated, an SR linked to the CG configuration (LCH-to CG mapping) may indicate the presence of valid or timely data in the UE buffer.

At 410, the method may include generating configured grant-uplink control information (CG-UCI). The operations of 410 may be performed in accordance with examples as described herein. In some implementations, aspects of the operations of 410 may be performed by a device as described with reference to FIG. 1.

Here, the CG-UCI may include information about how long the UE is not using the CG resources or which CG PUSCH resources of a CG PUSCH configuration the UE is not using for uplink transmission. Put another way, the CG-UCI may provide pause information related to an amount of time for which CG resources are not appropriate or used. For example, the CG-UCI may indicate an amount of time such as a number of milliseconds or intervals for a CG configuration or group of CG configurations. The amount of time may be associated with the amount of late or invalid data stored in the UE's buffer.

In an embodiment, the amount of time may be associated with an expected time at which data for a subsequent ADU will be available for transmission. In such an embodiment, the CG-UCI may indicate to the network that CG resources are no longer appropriate for a current ADU or frame that is not expected to be transmitted in a timely manner, but CG resources are requested for the next transmission.

A CG-UCI may be generated at 410 when a Hybrid Automatic Repeat Request (HARQ) process ID is given by a formula. In such an embodiment, the CG-UCI content may be different compared to an embodiment in which new radio-unlicensed (NR-U) is used.

At 415, the method may include adapting a logical channel prioritization (LCP) restriction. The operations of 415 may be performed in accordance with examples as described herein. In some implementations, aspects of the operations of 415 may be performed by a device as described with reference to FIG. 1.

When no valid or timely data associated with a CG resource is present in a UE's buffer, the UE may adaptively change LCP restriction rules. For example, the UE may adapt LCH to CG mapping to map valid or timely data to CG resources, and to remove mapping between the invalid data and the CG resources.

At 420, the method may include deprioritizing a CG. The operations of 420 may be performed in accordance with examples as described herein. In some implementations, aspects of the operations of 420 may be performed by a device as described with reference to FIG. 1.

In one embodiment, UE considers a configured grant associated with late data to be a deprioritized grant. In a specific embodiment, for the MAC entity configured with Ich-basedPrioritization, if the corresponding PUSCH transmission of a configured uplink grant is cancelled by CI-RNTI as specified in clause 11.2A of TS 38.213 or cancelled by a high PHY-priority PUCCH transmission as specified in clause 9 of TS 38.213, or a remaining delay budget of the associated packet or ADU is exceeded or a number of packet errors of the associated ADU exceeds a target, this configured uplink grant may be considered as a de-prioritized uplink grant. If this deprioritized uplink grant is configured with autonomousTx, the configuredGrantTimer for the corresponding HARQ process of this de-prioritized uplink grant is stopped if it is running.

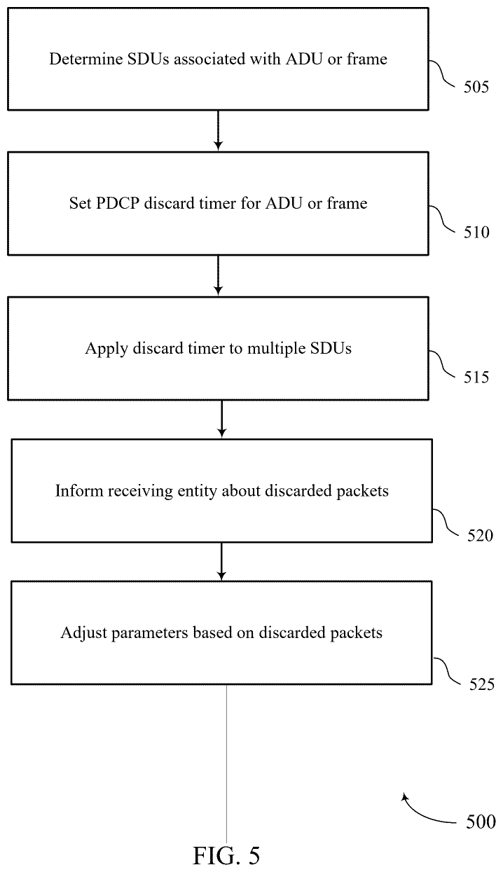

FIG. 5 illustrates a flowchart of a method 500 that supports discarding late data stored in the buffer of a UE in accordance with aspects of the present disclosure. The operations of the method 500 may be implemented by a device or its components as described herein. For example, the operations of the method 500 may be performed by a UE 104 as described with reference to FIGS. 1 through 2, while certain elements may be performed by a base station 102 or another network entity. In some implementations, the device may execute a set of instructions to control the function elements of the device to perform the described functions. Additionally, or alternatively, the device may perform aspects of the described functions using special-purpose hardware.

At 505, the method may include determining service data units (SDUs) associated with an ADU or frame associated with late data as determined at 305. The operations of 505 may be performed in accordance with examples as described herein. In some implementations, aspects of the operations of 505 may be performed by a device as described with reference to FIG. 1.

In an embodiment, the UE or PDCP transmitting entity determines which PDCP SDUs are associated with an ADU or frame that is not expected to be transmitted in time to be useful to an application at 505. In one example, a service data adaptation protocol (SDAP) header is provided with an ADU index or sequence number (SN), and the SDUs belonging to the same ADU or frame all have the same index or SN. That is, the SDUs are associated with an ADU or frame by the shared index or SN.

In another example the transmitting entity of, for example, a PDCP layer informs the receiving UE about the PDCP SNs belonging to the same ADU or frame. In one example, this information may be transmitted within a PDCP control PDU. Accordingly, a PCDP transmitting entity that is aware of ADU or frame size may inform the UE of an association, and determining SDUs associated with the ADU or frame may be performed by a UE by the information from the PCDP transmitting entity.

At 510, the method may include setting a PDCP discard timer for an ADU or frame. The operations of 510 may be performed in accordance with examples as described herein. In some implementations, aspects of the operations of 510 may be performed by a device as described with reference to FIG. 1.

In an embodiment, the UE or PDCP transmitting entity ensures that the PDCP discard timer has the same value for each PDPC service data unit (SDU) associated with an ADU or frame at 510. In one implementation the PDCP discard timer is maintained at an ADU or frame level, so that the PDCP SDUs associated with an ADU or frame are treated the same with respect to PDCP discard timer handling. Assigning the same discard timer to the SDUs associated with the ADU or frame may ensure that the PDCP discard timer of all the PDCP SDUs associated with the ADU or frame expire at the same time.

At 515, the method may include applying a discard timer for one SDU to a set of SDUs. The operations of 515 may be performed in accordance with examples as described herein. In some implementations, aspects of the operations of 515 may be performed by a device as described with reference to FIG. 1.

As an alternative to 510, at 515, a UE or PDCP transmitting entity considers the PDCP discard timer of all PDCP SDUs associated with an ADU/PDU set or frame as expired when the PDCP discard timer of one of the PDCP SDU, e.g. the first or earliest PDCP SDU, of an ADU or frame expires. In this embodiment, all SDUs associated with the late ADU or frame are discarded using a single timer value, instead of changing respective timer values as described for 510. From the PDCP point of view, PDCP discarding based on PDCP discard timer may be performed on a per-ADU or per-frame basis.

At 520, the method may include informing a receiving entity about packets discarded by the transmitter, e.g. a UE, and the receiving entity may adjust parameters based on the discarded packet information at 525. The operations of 520 and 525 may be performed in accordance with examples as described herein. In some implementations, aspects of the operations of 520 and 525 may be performed by a device as described with reference to FIG. 1.

Discarding a packet at the transmitter side may include informing the corresponding receiving entity about the discarded packets at 520. In particular, the receiving entity, e.g. a gNB, may be informed of SDUs that are discarded by the UE. The receiving entity may, based on identifiers of discarded packets such as SNs of the discarded packets, update its receiving window, and may prevent a request for RLC retransmissions for discarded RLC SDUs at 525. Otherwise, the receiving entity could assume that the packets were lost and request retransmission of data that is no longer of use to an application.

In particular, a T-reordering timer in the PDCP layer or a T-reassembly timer in the RLC may be updated, or stopped, when information about discarded packets is received. In addition, the UE may decline to transmit a radio link control (RLC) status report for discarded packets or a PDCP status report for discarded packets. Accordingly, the UE may adjust its parameters at 525 as well as the receiving entity.

In an embodiment, a new RLC control or status RLC protocol data unit (PDU) is transmitted which indicates to the RLC receiving entity which packets or SDUs have been discarded, for example by providing SN values of the discarded RLC SDUs. In one embodiment, an RLC transmitting entity informs the receiving entity about discarded packets at 520 using a new PDU format in which RLC PDUs associated with discarded RLC service data units SDUs include a header with SN values, but without any payload. In embodiments, an ADU may be used in place of the PDU set, and vice versa.

On receiving the new RLC control or status PDU or new RLC PDU format the receiving entity may update its timer status and receiving window status. For example, the receiving entity may update RX_NEXT, which serves as the lower bound of the receiving window. The RLC entity may inform the PDPC layer at the receiving side about the discarded packets so that the PDCP can update the timer status, e.g. the T-reordering timer, and the receiving window.

In an embodiment, when a PDB or discard timer expires and the related PDCP SDU contained in a transport block (TB) is in a HARQ buffer pending for retransmission, a UE may discard the TB and not further retransmit it. In particular, the UE may ignore a dynamic grant (DG) for retransmissions, and not perform autonomous retransmissions. Accordingly, the UE may adjust its parameters at 525 to avoid retransmission of data that is no longer useful to an application.

In an embodiment in which a timer expires which controls the PDB of an ADU, the MAC may inform a higher layer about the timer expiration. This timer event could be used to trigger certain actions at the RLC/PDCP layer, including advancing an RLC receiving window, not requesting RLC retransmission by an RLC status report or PDCP retransmission etc. depending on where the timer is maintained.

For example, the UE may start a counter or timer for a remaining delay budget (RDB) value based on a received DCI indicating a RDB. The RDB may be an amount of time remaining in a PDB. The time or count may be decremented by every slot associated with an ADU or frame, and when the counter or timer expires, the UE determines the delay budget is exceeded for the ADU or frame at 305. The UE may then indicate to a higher layer such as the application layer that the delay budget is exceeded for a frame or ADU at 315. If the counter or timer is running, and another DCI is received indicating an RDB for the ADU or frame, the counter or timer is restarted with one or more newly indicated RDB value.

Since the application layer may not benefit from packets which are late, it is helpful to ensure that data packets are successfully received within associated delay boundaries. The probability that a packet is late can be reduced by enhancements to a logical channel prioritization (LCP) process.

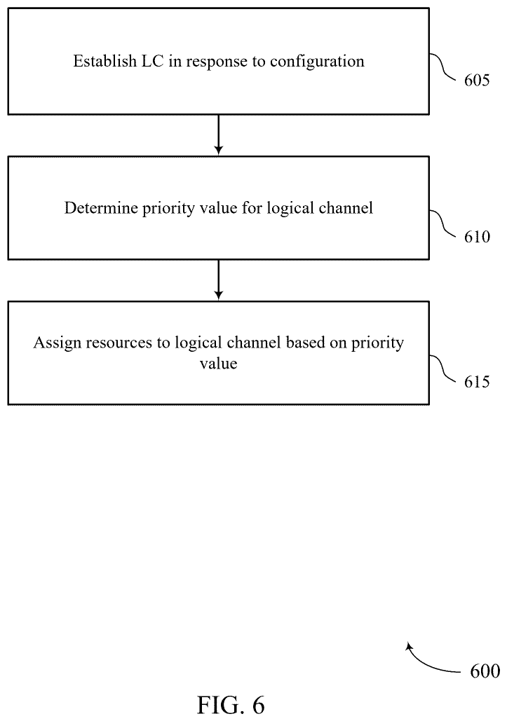

FIG. 6 illustrates a flowchart of a method 600 that supports logical channel prioritization in accordance with aspects of the present disclosure. The operations of the method 600 may be implemented by a device or its components as described herein. For example, the operations of the method 600 may be performed by a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 605, the method may include establishing a logical channel in response to a configuration. The operations of 605 may be performed in accordance with examples as described herein. In some implementations, aspects of the operations of 605 may be performed by a device as described with reference to FIG. 1.

The configuration of 605 may be an RRC Reconfiguration message which is used to establish a radio bearer. The RRC Reconfiguration message contains a logicalchannelconfig information element (IE) which carries LCH specific configuration fields, including priority values for the logical channels. The configuration may be received by a UE from a network entity such as a base station, e.g. a gNB.

In an embodiment, a radio bearer or logical channel is configured with a new field which indicates the LCH or radio bearer carries traffic for which a special treatment during LCP procedure is applied. The new field may be a field within the logicalchannelconfig information element. The field may indicate whether the priority values of the bearer or LCH can be adapted, or are static. In addition, or as an alternative, the field may indicate that the LCH or bearer carries XR traffic.

In a further implementation of the embodiment, a DCI allocating uplink resources (e.g. an UL DCI) for an initial transmission indicates within a field whether the uplink resources are specifically allocated for LCHs or radio bearers (RBs) which carry certain traffic such as XR traffic. In one example, such a field is a one-bit flag.

In response to receiving an UL DCI with an indication that the uplink resources are reserved for certain bearers or LCHs, for example bearers or LCHs carrying XR traffic, a UE may only consider those LCHs for which the network configured that uplink MAC SDUs from this logical channel can be transmitted on PUSCH resources reserved for certain bearers or LCHs, e.g. a field in the logicalchannelConfig indicating that an LCH or radio bearer that carries a specific traffic is present.

In one example, the field in the DCI indicates whether the PUSCH resources are reserved for XR traffic. In a specific embodiment, the field in the DCI may indicate whether PUSCH resources are reserved for an I frame or a P frame. Accordingly, the field within the logicalchannelConfig IE may indicate whether a MAC SDU of a LCH is allowed to be transmitted on PUSCH resources allocated by the DCI. Therefore, the field may be a restriction on an LCH.

At 610, the method may include determining a priority value for one or more logical channel. The priority value may be determined based on the logical channel priority from the network entity and a first parameter associated with uplink data assigned to the logical channel. The operations of 610 may be performed in accordance with examples as described herein. In some implementations, aspects of the operations of 610 may be performed by a device as described with reference to FIG. 1. Specific embodiments of determining a priority value for a logical channel are described with respect to method 700 below.

At 615, the method may include assigning resources to the logical channel with the determined priority based on the priority value determined at 610. The operations of 615 may be performed in accordance with examples as described herein. In some implementations, aspects of the operations of 615 may be performed by a device as described with reference to FIG. 1. The resources assigned to the logical channel may be the resources allocated by the uplink grant or UL DCI received at 605.

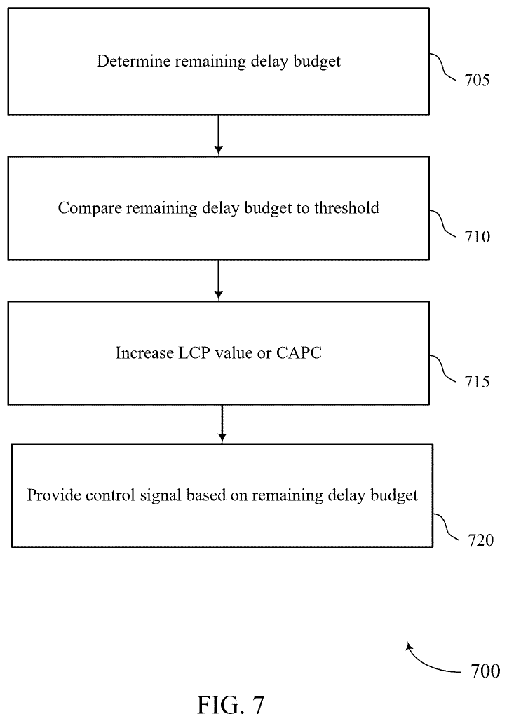

FIG. 7 illustrates a flowchart of a method 700 that supports determining a priority value for a logical channel in accordance with aspects of the present disclosure. The operations of the method 700 may be implemented by a device or its components as described herein. For example, the operations of the method 700 may be performed by a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 705, the method may include determining a remaining delay budget (RDB). The operations of 705 may be performed in accordance with examples as described herein. In some implementations, aspects of the operations of 705 may be performed by a device as described with reference to FIG. 1.

In an embodiment, the RDB is the difference between a PDB for an ADU, frame or packet and a current time, or an amount of time remaining in a PDB. Therefore, determining an RDB may include determining the difference between a current time and a PDB for an ADU, frame or packet. The difference is the amount of time remaining in the delay budget.

At 710, the method may include comparing the remaining delay budget to a predetermined value. The operations of 710 may be performed in accordance with examples as described herein. In some implementations, aspects of the operations of 710 may be performed by a device as described with reference to FIG. 1.

In an embodiment, the UE increases the priority of a LCH when packets of the LCH which are pending for transmission are approaching the PDB. This condition may be determined by comparing the RDB to a threshold value at 710, and the priority may be increased at 715 when the remaining delay budget of an ADU, frame or packet is below the threshold value.

The threshold value may be a set preconfigured value. For example, the threshold value may be a time such as a number of milliseconds before the expiration of a PDB. In such an embodiment, the UE may increase the priority of a LCH based on comparing the RDB to the preconfigured value.

At 715, the method may include increasing a logical channel value or channel access priority class (CAPC). The operations of 715 may be performed in accordance with examples as described herein. In some implementations, aspects of the operations of 715 may be performed by a device as described with reference to FIG. 1.

In an embodiment, the LCH priority is increased by a predefined step value. For example, the LCH priority may be increased according to the following algorithm: Priority_{new}=Priority_{old}−X. The LCH priority is an integer value between 1 and 8, with 1 being the highest priority. Accordingly, the value of X may be an integer equal to or greater than 1.

In addition or as an alternative, the LCH priority may be set to 1, or the highest LCH priority. In an embodiment, the LCH priority may be set to 1 depending on the difference between the RDB and the PDB. In such an embodiment, if a UE determines that the RDB is equal to or less than a predetermined value, then the priority is elevated to the highest possible level. For example, if the remaining delay budget is within X milliseconds of the packet delay budget, the priority value for an LCH may be set to 1.

In another embodiment, the UE increases the priority of a LCH by steps when the RDB of packets of the LCH pending for transmission fall within a predefined range. The steps may be a series of priority values by which the priority is increased depending on the RDB. For example, the UE may increase the LCH priority by a first step when the RDB is smaller than a first predetermined value, and the UE may the LCH priority by a second step when the RDB is smaller than a second predetermined value, etc. The values of the steps may be the same or different, and may increase as the RDB decreases. In an embodiment, one or more LCH with an RDB that is the same or less than a predefined threshold value is treated with higher priority than MAC control elements (CEs).

When a UE is operating in a shared spectrum environment, the UE may increase the CAPC (channel access priority class) at 715 when the RDB is less than a preconfigured threshold when a transport block (TB) for which listen before talk (LBT) is performed contains data associated with an RDB that is less than a preconfigured threshold. In such an embodiment, the CAPC may be treated the same as the priority values described above. For example, the CAPC may be incremented, set to a highest priority class, adjusted to different levels depending on the RDB, etc.

In an embodiment, the UE may prioritize data of certain LCHs or other uplink channels over other uplink data when the UE is power limited according to the RDB of a packet, frame or ADU. For example, the UE may prioritize a PUSCH transmission carrying MAC SDU(s) of a LCH for which the RDB is smaller than a preconfigured threshold over another PUSCH transmission, or over particular PUCCH transmissions, to ensure that the PDB is not exceeded.

In an embodiment, an RDB is considered when determining the prioritization order of UL channels for cases when the UE is power limited. For example, power scaling or dropping of UL channel transmission may be applied.

At 720, the method may include providing a control signal based on the remining delay budget. The operations of 720 may be performed in accordance with examples as described herein. In some implementations, aspects of the operations of 720 may be performed by a device as described with reference to FIG. 1.

In an embodiment, the UE indicates within a BSR the RDB of the corresponding data for which the buffer level was reported. In one example a BSR may comprise a RDB value for every LCH or LCG in the BSR.

The UE may trigger a BSR or SR when the RDB of data which is pending for transmission is below a configured threshold. In such an embodiment, the UE may ignore the SR prohibit timer and trigger an SR even when an SR prohibit timer is running. The UE may trigger an SR only for specific or preconfigured logical channels when an RDB falls below a threshold value for those logical channels.

Certain applications have dependencies between different streams of data. This is especially true for video data, and in particular for XR applications. Certain inter-dependencies between transmissions of different bearers, LCHs or flows may be taken into account by embodiments of the present disclosure. For example, frame or ADU level QoS constraints for XR and the dependency of different QoS flows may be provided.

XR services include multiple types of data which may include I-frame or P-frame for video streams, audio streams, pose and control streams, etc. Different streams may correspond to different QoS flows or radio bearers and may have different QoS requirements, while there may be dependency among different streams. For example, decoding of a P-frame may be dependent on decoding of the latest I-frame.

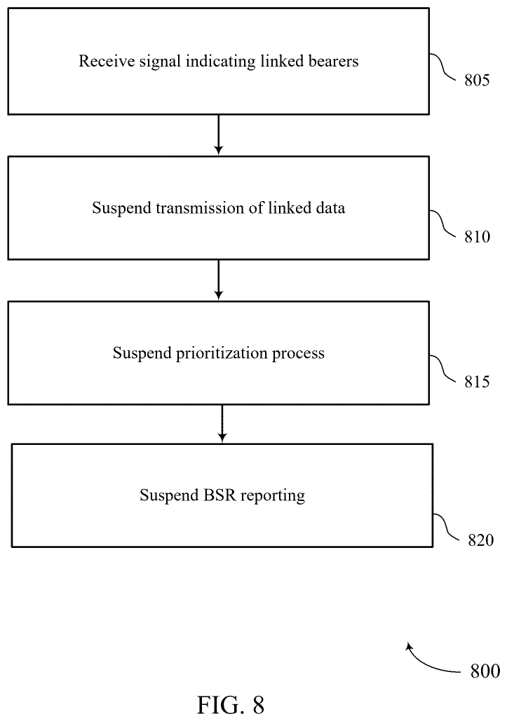

FIG. 8 illustrates a flowchart of a method 800 that supports dependencies between data and associated processes in accordance with aspects of the present disclosure. The operations of the method 800 may be implemented by a device or its components as described herein. For example, the operations of the method 800 may be performed by a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 805, the method may include receiving a signal indicating that bearers with related data are linked. The operations of 805 may be performed in accordance with examples as described herein. In some implementations, aspects of the operations of 805 may be performed by a device as described with reference to FIG. 1.

A bearer may be linked to another bearer at 805. In one example, a radio bearer or radio link control (RLC) bearer is linked to one or more radio bearer or RLC bearer. Examples of linked bearers include a radio bearer carrying an I-frame that is linked with one or more bearer carrying P-frames. Another example is the transmission of left eye and right eye video streams being mapped to two linked bearers or LCHs. Accordingly, bearers may be linked when data of the linked bearers has some association or dependency between them.

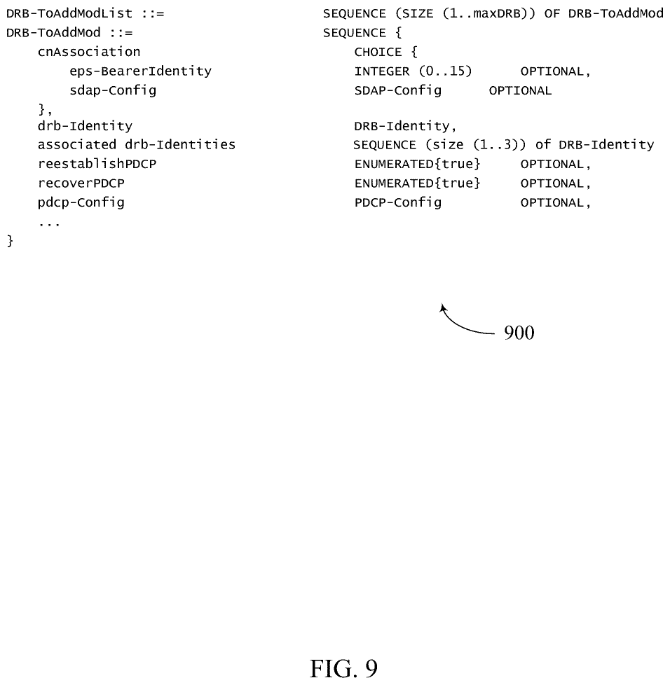

Linking bearers may include providing data to a data field indicating the link. In one example a new field in the Radiobearerconfig IE indicates one or more identities of the associated radio bearer. For example, the DRBToAddMod IE may contain a field which refers to the identity, such as the data radio bearer identity (DRB ID), of one or more associated bearers. An example of an IE 900 with a field for associated DRB identities is provided in FIG. 9. According to another example, the logicalchannelconfig IE comprises a field identifying an associated RLC bearer or logical channel. The UE may receive the IE at 805.

At 810, the method may include suspending the transmission of data associated with a linked bearer. The operations of 810 may be performed in accordance with examples as described herein. In some implementations, aspects of the operations of 810 may be performed by a device as described with reference to FIG. 1.

In an embodiment, the UE suspends the transmission of first data of a first LCH until transmission of second data of a second LCH has been acknowledged by the network. For example, when the fist data is linked to the second data at 805, for example by linking the bearers or channels of the data, the UE may suspend transmission of the first data until an event such as an ACK that the second data has been successfully received by a network entity. In another embodiment, the UE may suspend transmitting the first data until some other event occurs, such as the expiration of a timer.

In an example, the UE transmits an I-frame, and suspends transmitting associated P-frames until receipt of the I-frame is acknowledged by a network entity. After receiving an explicit acknowledgement, e.g. an ACK, or an implicit acknowledgment such as the expiration of a timer, the UE removes the suspension and transmits the P-frames linked to the I-frame.

In one example, UE shall after the transmission of an I-frame, or the last PDCP/RLC PDU of the I-frame, poll a RLC status report to confirm the reception of the I-frame. Alternatively, and according to another example, a UE or other transmitting entity may request the transmission of a PDCP status report after the transmission of a I-frame.

In one example, a UE is configured by the network whether to suspend a LCH, such as a LCH carrying a P-frame, until the transmission of data of another LCH is confirmed, since for some use cases suspension might not be appropriate. In other words, the UE may be configured to suspend linked data or to not suspend linked data under certain circumstances. When a UE is configured with carrier aggregation, I-frames and P-frames may be transmitted or mapped on a different carrier. For such a scenario, it might not be appropriate to suspend the LCH carrying the P-frames until the transmission of an I-frame was confirmed.

At 815, the method may include suspending a prioritization process. The operations of 815 may be performed in accordance with examples as described herein. In some implementations, aspects of the operations of 815 may be performed by a device as described with reference to FIG. 1. In particular, the prioritization process suspended at 815 may be the logical channel prioritization process 600 discussed above. If first data is not received within a PDB, then none of the data associated with the first data may be of any utility to an application. Accordingly, resources may be conserved by waiting until receipt of the first data is acknowledge before advancing the priority of the second data.

At 820, the method may include suspending BSR reporting. The operations of 820 may be performed in accordance with examples as described herein. In some implementations, aspects of the operations of 820 may be performed by a device as described with reference to FIG. 1.

In an embodiment, BSR reports are suspended for a bearer carrying first data such as a P-frame until the transmission of second data such as an I-frame is acknowledged. In an example, upon suspension of data of a LCH, the data is considered unavailable for the LCH at least for the purpose of BSR reporting.

In an embodiment, a new type of bearer is used for the transmission of a QoS flow which is comprised of packets of different priority. Examples of such a bearer are a XR bearer carrying separate streams for left and right eye video or separate streams for I and P frames. In one example the bearer is comprised of a PDCP entity which has two or more associated RLC entities, which is similar to a split bearer.

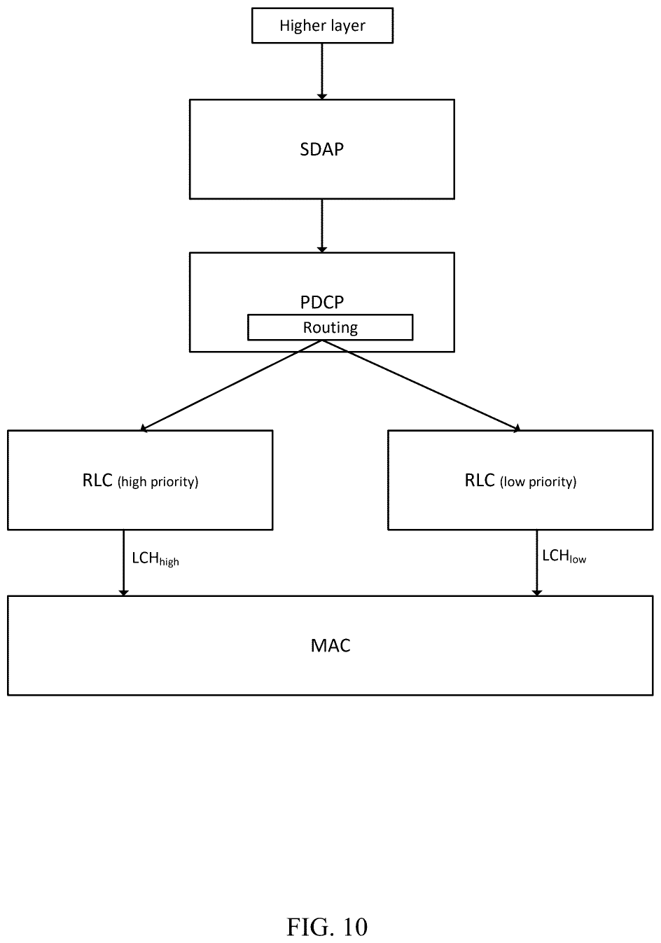

FIG. 10 illustrates an example of a protocol stack for splitting bearers with different priorities in accordance with aspects of the present disclosure.

As illustrated in FIG. 10, data is sent from a higher layer, which may be an IP layer, to the SDAP layer, and then transmitted to the PDCP layer. According to an embodiment, one PDCP entity may be associated with multiple RLC entities or logical channels which may have different logical channel priorities to support packets of different priority level within one radio bearer or QoS flow.

For example, a XR traffic QoS flow may support critical packets of higher priority or urgency than other packets. Those high priority packets may be prioritized over other packets within the same radio bearer or the QoS flow. In one example, the left eye video stream may be mapped to one RLC entity or LCH while the right eye video stream may be mapped to another RLC entity or LCH associated with the same PDCP entity.

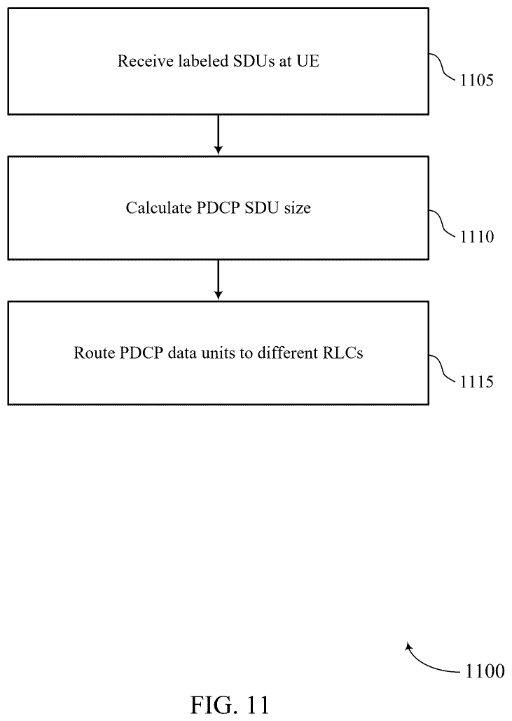

FIG. 11 illustrates a flowchart of a method 1100 that supports different bearer priorities in accordance with aspects of the present disclosure. The operations of the method 1100 may be implemented by a device or its components as described herein. For example, the operations of the method 1100 may be performed by a UE 104 as described with reference to FIGS. 1 through 2. In some implementations, the device may execute a set of instructions to control the function elements of the device to perform the described functions. Additionally, or alternatively, the device may perform aspects of the described functions using special-purpose hardware.

In an embodiment, the SDAP layer provides an indication in the SDAP header which is used to route the SDUs to the different RLC entities associated with the PDCP layer. In a legacy environment, an SDAP data PDU may include an optional 1-byte header. Uplink and downlink SDAP headers may be configured per DRB. In another embodiment, such packet marking or labelling may be performed by a higher layer such as application layer.

A downlink SDAP header may include a 1-bit RDI (Reflective QoS flow to DRB mapping Indication), a 1-bit RQI (Reflective QoS Indication) and a 6-bit QFI (QOS Flow Identifier). An uplink SDAP header includes QFI. In one example, a new field is included in the SDAP header which indicates routing information such as whether a packet or PDCP SDU is a high priority packet which is used in the PDCP layer for routing to high priority RLC entities. In such an embodiment, a high priority SDU may be routed to the high priority LCH associated with the PDCP entity. Conversely, a low priority SDU may be routed to a low priority LCH associated with the PDCP entity based on data in the new field.

At 1105, the method may include receiving labeled SDUs at the UE. The operations of 1105 may be performed in accordance with examples as described herein. In some implementations, aspects of the operations of 1105 may be performed by a device as described with reference to FIG. 1.

In an embodiment, the PDCP entity in the UE receives SDUs with labels indicating whether the SDU is considered urgent, and routing information which may be used in the PDCP layer for routing to appropriate RLC entities or LCHs. The PDCP PDU containing a SDU marked as a high priority packet will be submitted to another RLC entity (RLC entity other than the one used for “normal” packets) handling such critical packets. If there are different levels of urgency, then the PDCP PDU containing such SDU may be submitted to RLC entities handling the corresponding urgency level. Accordingly, particular RLC entities or LCHs may support respective urgency levels.

At 1110, the method may include calculating a PDCP SDU size. The operations of 1110 may be performed in accordance with examples as described herein. In some implementations, aspects of the operations of 1110 may be performed by a device as described with reference to FIG. 1.

In an embodiment, a UE computes the data volume of a bearer for the purpose of buffer status reporting as the sum of the PDCP data volume and the data volumes of the associated RLC entities. In an example, multiple RLC entities associated with the PDCP entity may be mapped to the same LCG.

In another example, a UE splits the data volume of the common PDCP entity among the multiple associated RLC entities in order to compute a data volume per RLC bearer, so that the data volume of the RLC bearer corresponds to the sum of the RLC data volume and the amount of the PDCP data volume which is associated with the corresponding RLC entity.

At 1115, the method may include routing PDCP data units to different priority RLCs. The operations of 1115 may be performed in accordance with examples as described herein. In some implementations, aspects of the operations of 1115 may be performed by a device as described with reference to FIG. 1.

The UE may route PDCP data units with different urgency or priority values to different RLCs with the corresponding urgency values at 1115. Although only two urgency levels are shown in FIG. 10—high and low—in other embodiments, more than two urgency levels are possible.

In an embodiment in which a PDCP entity is associated with two different RLC entities—for example, one for left eye video and another LCH for right eye video—the PDCP data volume is split in 2 parts, one of which corresponds to the left eye PDCP SDUs or PDUs and one which corresponds to the right eye PDCP SDUs or PDUs. The data may be split based on other factors as well.

In another example the routing of PDCP PDUs or SDUs to the associated RLC entities or LCHs is performed based on the packet size, or PDCP SDU size as determined at 1115. According to one embodiment, a UE may route the PDCP PDUs or SDUs to the associated RLC entities depending on whether the PDCP SDU size is larger than a predefined threshold.

In an embodiment, one PDCP entity is associated with two RLC entities which are configured to respectively carry I-frames and P-frames. Since the mean packet size of an I-frame is considerably larger than the mean packet size of a P-frame, the PDCP entity may consider perform PDCP SDU routing based on the packet size. For example, when a PDCP SDU size is larger than a preconfigured threshold the corresponding PDCP PDU may be routed to a first RLC entity, while other PDCP PDUs in which an PDCP SDU size is smaller than the preconfigured threshold are routed to a second RLC entity with a different urgency level from the first RLC entity.

While embodiments have been described with respect to left and right eye information and I and P frame data, the scope of the present disclosure is not limited to these specific examples. Persons of skill in the art will recognize that many different implementations are possible to minimize the possibility that data is transmitted in time to be useful to an application, and to prevent the transmission of data that is no longer useful to the application.

It should be noted that the methods described herein describe possible implementations, and that the operations and the steps may be rearranged or otherwise modified or omitted and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1-20. (canceled)

21. A User Equipment (UE) for wireless communication, comprising:
at least one memory; and
at least one processor coupled with the at least one memory and configured to cause the UE to:
receive a Configured Grant (CG) configuration allocating multiple CG Physical Uplink Shared Channel (PUSCH) resources;
determine whether to use an allocated CG PUSCH resource for a PUSCH transmission based at least in part on an amount of data buffered at the UE;
generate Uplink Control Information (UCI) that indicates one or more unused CG PUSCH resources; and
transmit the UCI.

22. The UE of claim 21, wherein the UCI further indicates an amount of time for pausing PUSCH transmission on the one or more unused CG PUSCH resources.

23. The UE of claim 22, wherein the UCI further indicates an amount of invalid data buffered at the UE.

24. The UE of claim 23, wherein the amount of time for pausing PUSCH transmission is associated with the amount of invalid data buffered at the UE.

25. The UE of claim 21, wherein the UCI further indicates a request for one or more subsequent CG PUSCH resources for a subsequent PUSCH transmission.

26. The UE of claim 21, wherein the UCI is transmitted in the CG PUSCH resources allocated by the CG configuration.

27. A processor for wireless communication, comprising:
at least one controller coupled with at least one memory and configured to cause the processor to:
receive a Configured Grant (CG) configuration allocating multiple CG Physical Uplink Shared Channel (PUSCH) resources;
determine whether to use an allocated CG PUSCH resource for a PUSCH transmission based at least in part on an amount of data buffered at a User Equipment (UE) associated with the controller;
generate uplink control information that indicates one or more unused CG PUSCH resources; and
transmit the UCI.

28. The processor of claim 27, wherein the UCI further indicates an amount of time for pausing PUSCH transmission on the one or more unused CG PUSCH resources.

29. The processor of claim 27, wherein the UCI further indicates an amount of invalid data buffered at the UE.

30. The processor of claim 27, wherein the amount of time for pausing PUSCH transmission is associated with the amount of invalid data buffered at the UE.

31. The processor of claim 27, wherein the UCI further indicates a request for one or more subsequent CG PUSCH resources for a subsequent PUSCH transmission.

32. The processor of claim 27, wherein the UCI is transmitted in the CG PUSCH resources allocated by the CG configuration.

33. A method performed by a User Equipment (UE), the method comprising:
receiving a Configured Grant (CG) configuration allocating multiple CG Physical Uplink Shared Channel (PUSCH) resources;
determining whether to use an allocated CG PUSCH resource for a PUSCH transmission based at least in part on an amount of data buffered at the UE;
generating Uplink Control Information (UCI) that indicates one or more unused CG PUSCH resource; and
transmitting the UCI.

34. The method of claim 33, wherein the UCI further indicates an amount of time for pausing PUSCH transmission on the one or more unused CG PUSCH resources.

35. The method of claim 33, wherein the UCI further indicates an amount of invalid data buffered at the UE.

36. The method of claim 33, wherein the amount of time for pausing PUSCH transmission is associated with the amount of invalid data buffered at the UE.

37. The method of claim 33, wherein the UCI further indicates a request for one or more subsequent CG PUSCH resources for a subsequent PUSCH transmission.

38. The method of claim 33, wherein the UCI is transmitted in the CG PUSCH resources allocated by the CG configuration.
